(19) United States
(12) Patent Application Publication
(10) Pub. No.: US 2019/0149370 A1
(43) Pub. Date: May 16, 2019

(54) BASEBAND PROCESSING APPARATUS AND BASEBAND PROCESSING METHOD BASED ON ORTHOGONAL FREQUENCY-DIVISION MULTIPLEXING

(71) Applicant: Institute For Information Industry, Taipei (TW)

(72) Inventors: Shih-Kai Lee, New Taipei City (TW); Ming-Ju Wu, Taipei City (TW); Huang-Chang Lee, Taipei City (TW)

(21) Appl. No.: 15/831,345

(22) Filed: Dec. 4, 2017

(30) Foreign Application Priority Data
Nov. 16, 2017 (TW) 106139719

(51) Int. Cl. H04L 25/49; H04L 27/26; H04L 5/00; H04L 5/02

(52) U.S. Cl. CPC H04L 25/49; H04L 27/265; H04L 27/2614; H04L 27/2602; H04L 5/0007; H04L 27/2628; H04L 5/026; H04L 27/2691

(57) ABSTRACT

Embodiments relate to a baseband processing apparatus and a baseband processing method based on orthogonal frequency-division multiplexing (OFDM). In order to solve the problem of high PAPR in OFDM systems, the baseband processing apparatus and method generate a plurality of data with different peak to average power ratios (PAPRs) by modifying bit representations of the frozen bits used by a polar code encoder, and then select the one of the plurality of data with the smallest PAPR as an OFDM signal.

### PRIORITY

This application claims priority to Taiwan Patent Application No. 106139719 filed on Nov. 16, 2017, which is hereby incorporated by reference in its entirety.

### FIELD

Embodiments of the present invention relate to a baseband processing apparatus and a baseband processing method. More particularly, the embodiments of the present invention relate to a baseband processing apparatus and a baseband processing method based on orthogonal frequency-division multiplexing.

### BACKGROUND

Orthogonal frequency-division multiplexing (OFDM) is a kind of technology for modulation and demodulation of digital data on a plurality of carrier frequencies. Generally, the technical core of the OFDM is to divide a whole frequency band into a plurality of sub-carriers orthogonal to each other and transmit data on these sub-carriers in parallel, thereby improving the data transmission rate and the bandwidth utilization efficiency.

In conventional OFDM systems, the amplitude of an OFDM signal varies greatly because the OFDM signal is a linear sum of a plurality of sub-carrier signals, and this makes the OFDM signal usually have a high peak to average power ratio (PAPR). Once the OFDM signal has a too high PAPR, the operation of the conventional OFDM system will be affected. For example, the OFDM signal of a high PAPR severely affects the amplification efficiency of a power amplifier, conversion quality of a digital to analog converter (DAC) or an analog to digital converter (ADC) or the like.

Accordingly, an urgent need exists in the art to improve the problem of a high PAPR for the OFDM signal.

### SUMMARY

To solve at least the aforesaid problem, some embodiments of the present invention provide a baseband processing apparatus based on orthogonal frequency-division multiplexing (OFDM), and the baseband processing apparatus may comprise a polar code encoder, a modulator, an inverse discrete Fourier transformer and a controller. The modulator may be electrically connected with the polar code encoder, the inverse discrete Fourier transformer may be electrically connected with the modulator, and the controller may be electrically connected with the inverse discrete Fourier transformer. The polar code encoder may be configured to encode a plurality of first data into a plurality of second data, each of the first data comprises an information bit set and a frozen bit set, the plurality of information bit sets have the same bit length and the same bit representation as each other, the plurality of frozen bit sets have the same bit length as each other, each of the frozen bit sets comprises a specific frozen bit set, and the plurality of specific frozen bit sets have the same bit length as each other but different bit representations from each other. The modulator may be configured to modulate the plurality of second data into a plurality of third data. The inverse discrete Fourier transformer may be configured to transform the plurality of third data into a plurality of fourth data. The controller may be configured to calculate a peak to average power ratio (PAPR) of each of the plurality of fourth data and select a fourth data candidate from the plurality of fourth data that corresponds to the smallest one of the PAPRs.

To solve at least the aforesaid problem, some embodiments of the present invention further provide a baseband processing method based on orthogonal frequency-division multiplexing (OFDM), and the method may comprise the following steps:

encoding, by a polar code encoder, a plurality of first data into a plurality of second data, each of the first data comprising an information bit set and a frozen bit set, the plurality of information bit sets having the same bit length and the same bit representation as each other, the plurality of frozen bit sets having the same bit length as each other, each of the frozen bit sets comprising a specific frozen bit set, and the plurality of specific frozen bit sets having the same bit length as each other but different bit representations from each other;

modulating, by a modulator, the plurality of second data into a plurality of third data;

transforming, by an inverse discrete Fourier transformer, the plurality of third data into a plurality of fourth data; and

calculating, by a controller, a peak to average power ratio (PAPR) of each of the plurality of fourth data and selecting, by the controller, a fourth data candidate from the plurality of fourth data that corresponds to the smallest one of the PAPRs.

In the embodiments of the present invention, a plurality of data with different PAPRs may be generated by modifying bit representations of the frozen bits used by a polar code encoder, and then the one of the plurality of data with the smallest PAPR is selected as an OFDM signal. As compared to the conventional OFDM system in which the PAPR of the OFDM signal cannot be adjusted, the PAPR of the OFDM signal is adjustable in the embodiments of the present invention. Therefore, the embodiments of the present invention can effectively solve the problem of a high PAPR for the OFDM signal.

This summary is not intended to encompass all embodiments of the present invention but is provided only to overall describe the core concept of the present invention and cover the problem to be solved, the means to solve the problem and the effect of the present invention to provide a basic understanding of the present invention by a person having ordinary skill in the art.

### BRIEF DESCRIPTION OF THE DRAWINGS

FIG. 1A illustrates a baseband processing apparatus based on orthogonal frequency-division multiplexing (OFDM) in one or more embodiments of the present invention;

FIG. 1B illustrates another baseband processing apparatus based on OFDM in one or more embodiments of the present invention;

FIG. 2A to FIG. 2B are schematic views illustrating operation of a polar code encoder in one or more embodiments of the present invention;

FIG. 3 is a schematic view illustrating operation of another polar code encoder in one or more embodiments of the present invention; and

FIG. 4 illustrates a baseband processing method based on OFDM in one or more embodiments of the present invention.

### DETAILED DESCRIPTION

The Example embodiments of the present invention described below are not intended to limit the present invention to any specific examples, embodiments, environment, applications, structures, processes or steps described in these example embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

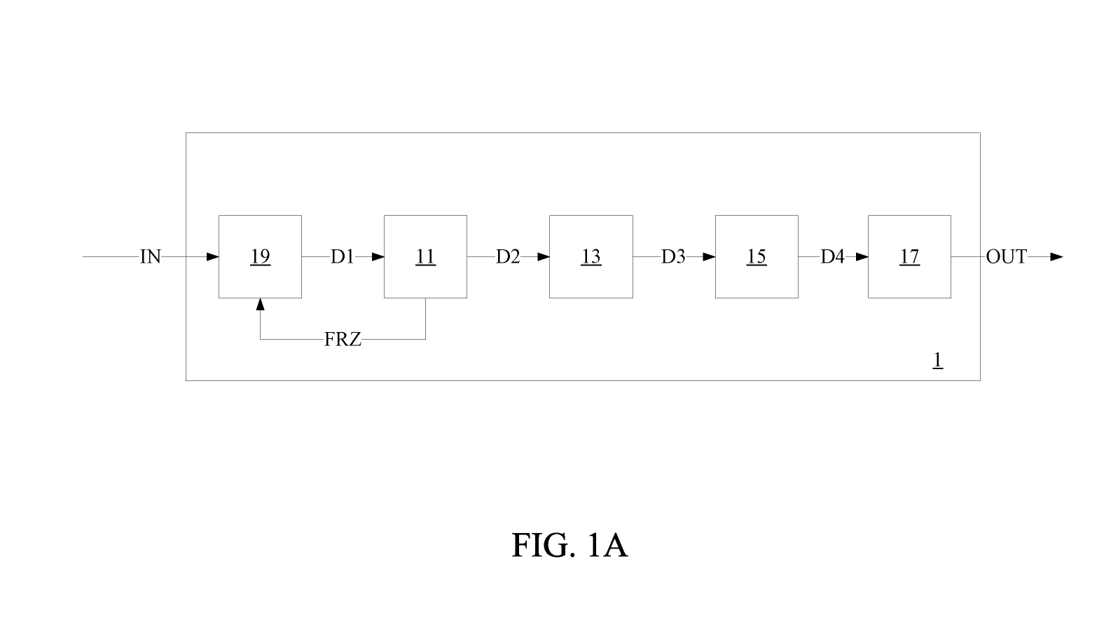

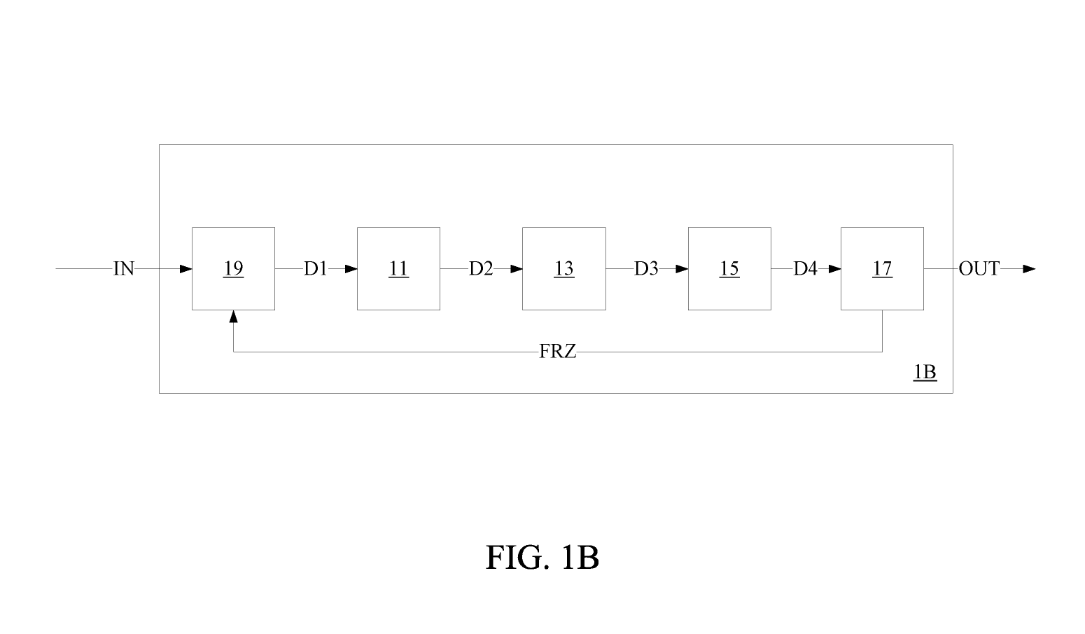

FIG. 1A illustrates a baseband processing apparatus 1A based on OFDM in one or more embodiments of the present invention, and FIG. 1B illustrates another baseband processing apparatus 1B based on OFDM in one or more embodiments of the present invention. Contents shown in FIG. 1A and FIG. 1B are only for purpose of illustrating embodiments of the present invention instead of limiting the present invention. Each of the baseband processing apparatus 1A and the baseband processing apparatus 1B may be applied to an orthogonal frequency-division multiplexing (OFDM) transmitter and may be used for processing of various digital signals, which is for example but not limited to: coding, modulation, inverse discrete Fourier Transform (IDFT) or the like. Each of the baseband processing apparatus 1A and the baseband processing apparatus 1B may be integrated into a system on chip (SoC), but it is not limited thereto.

Referring to FIG. 1A and FIG. 1B, each of the baseband processing apparatus 1A and the baseband processing apparatus 1B may substantially comprise a polar code encoder 11, a modulator 13, an inverse discrete Fourier transformer 15, a controller 17 and an interleaver 19. The polar code encoder 11 may be electrically connected to the modulator 13, the modulator 13 may be electrically connected to the inverse discrete Fourier transformer 15, and the inverse discrete Fourier transformer 15 may be electrically connected to the controller 17. In the baseband processing apparatus 1A, the interleaver 19 may be electrically connected to the polar code encoder 11. In the baseband processing apparatus 1B, the interleaver 19 may be electrically connected to the polar code encoder 11 and the controller 17.

In some embodiments, each of the baseband processing apparatus 1A and the baseband processing apparatus 1B may further comprise other elements/modules to perform other digital signal processing required by the OFDM transmitter. The connection between blocks in FIG. 1A and FIG. 1B may be direct connection (i.e., connection not via other elements with specific functions) or indirect connection (i.e., connection via other elements with specific functions).

The polar code encoder 11 is an encoder adopting a polar code. The polar code belongs to one kind of forward error correction codes, and may reach Shannon Limit theoretically. The polar code may achieve channel polarization, and the channel polarization may enable each of channels to present different reliability from each other. As the encoding length of the polar code increases, the channel capability of part of channels will be close to one (noiseless channels) and the channel capability of part of channels will be close to zero (pure-noise channels) A message transmitted on a perfect channel may theoretically reach the Shannon Limit. The polar code encoder 11 may be implemented by an integrated circuit (IC), but it is not limited thereto.

The modulator 13 is a digital modulator. Depending on different modulation requirements, the modulator 13 may have different structures which are for example but not limited to: an amplitude shift keying (ASK) structure, a frequency shift keying (FSK) structure, a phase shift keying (PSK) structure and a quadrature amplitude modulation (QAM) structure or the like. The modulator 13 may be implemented by an integrated circuit, but it is not limited thereto.

The inverse discrete Fourier transformer 15 is a transformer capable of achieving inverse discrete Fourier transformation. Depending on different transformation requirements, the inverse discrete Fourier transformer 15 may have different structures which are for example but not limited to: a common inverse discrete Fourier transform structure and an inverse fast Fourier transform (IFFT) structure that is easy to be implemented on hardware. The inverse discrete Fourier transformer 15 may be implemented by an integrated circuit, but it is not limited thereto.

The controller 17 is a microprocessor or a microcontroller. The microprocessor or the microcontroller is a programmable specific integrated circuit that is capable of operating, storing, outputting/inputting or the like. Moreover, the microprocessor or the microcontroller can receive and process various coded instructions, thereby performing various logical operations and arithmetical operations and outputting corresponding operation results.

The interleaver 19 is an apparatus that is configured to interleave and/or rearrange a plurality of input bits to generate a plurality of interleaved and/or rearranged output bits.

Referring to FIG. 1A and FIG. 1B, each of the baseband processing apparatus 1A and the baseband processing apparatus 1B may receive a digital input signal IN and output a digital output signal OUT. The polar code encoder 11 may be configured to encode a plurality of first data D1 into a plurality of second data D2. Each of the first data D1 is represented by a string of binary bits, and may comprise an information bit set (i.e., information bits carried in the digital input signal IN) and a frozen bit set (i.e., frozen bits FRZ decided and/or generated by the polar code encoder 11 or the controller 17). The plurality of information bit sets have the same bit length and the same bit representation as each other because the plurality of information bit sets are from the information bits carried in the same digital input signal IN. The plurality of frozen bit sets have the same bit length as each other but different bit representations from each other. In the baseband processing apparatus 1A, the interleaver 19 may be configured to interleave and/or rearrange the information bits carried in the digital input signal IN and each set of frozen bits FRZ decided and/or generated by the polar code encoder 11 so as to generate a plurality of first data D1. In the baseband processing apparatus 1B, the interleaver 19 may be configured to interleave and/or rearrange the information bits carried in the digital input signal IN and each set of frozen bits FRZ decided and/or generated by the controller 17 so as to generate a plurality of first data D1.

The plurality of same bit lengths of the plurality of frozen bit sets may depend on a code rate adopted by the polar code encoder 11. The code rate may be defined as a ratio of the bit length of the information bit set comprised in the first data D1 to the bit length of the first data D1. For example, if the code rate adopted by the polar code encoder 11 is ½, and the bit length of the information bit set (i.e., the information bit data carried in the digital input signal IN) comprised in the first data D1 is four (i.e., four bits), then the polar code encoder 11 will form the frozen bit set comprised in the first data D1 with four frozen bits so that the ratio of the bit length of the information bit set to the bit length of the first data D1 is ½.

Each of the frozen bit sets may comprise a specific frozen bit set, and the plurality of specific frozen bit sets have the same bit length as each other but different bit representations from each other. In some embodiments, the bit length of the specific frozen bit set may be equal to the bit length of the frozen bit set, i.e., all the bits of the frozen bit set may be selected to form the specific frozen bit set. In some embodiments, the bit length of the specific frozen bit set may be less than the bit length of the frozen bit set, i.e., one or part of the bits of the frozen bit set may be selected to form the specific frozen bit set. For example, if the bit length of the frozen bit set is four (i.e., four bits), then the bit length of the specific frozen bit set comprised in the frozen bit set may be one, two, three or four, i.e., one, two, three or four bits among the four bits may be selected to form the specific frozen bit set.

The plurality of specific frozen bit sets have different bit representations. For example, since each bit may be represented as zero or one, the specific frozen bit set may have at most 2⁴ (i.e., 16) different bit representations depending on the bit length of the specific frozen bit set (which may be one, two, three or four bits) if the bit length of the frozen bit set is four (i.e., four bits). The number of the plurality of first data D1 encoded by the polar code encoder 11 may depend on the number of specific frozen bit sets having different bit representations, so it may be represented as 2^{r} (where r is a positive integer) and equivalent to the bit length of the specific frozen bit set. For example, if the bit length of the specific frozen bit set is three, then the number of the specific frozen bit sets having different bit representations and the number of the first data D1 encoded by the polar code encoder 11 are all eight (i.e., 2³).

Under the architecture of the polar code, once the bit length of the frozen bit set is determined, the bit reliability of each bit comprised in the frozen bit set is also determined. Therefore, in some embodiments, the polar code encoder 11 may decide the plurality of specific frozen bit sets from the plurality of frozen bit sets respectively according to bit reliability of frozen bits. For example, if the bit length of the frozen bit set is four (i.e., four bits) and the bit length of the specific frozen bit set is determined as two (i.e., two bits), then the polar code encoder 11 may select two bits having the highest reliability from the four bits to form the specific frozen bit set.

Under the architecture of the polar code, once the bit length of the frozen bit set is determined, the bit position of each bit comprised in the frozen bit set is also determined. Therefore, in some embodiments, the polar code encoder 11 may decide the plurality of specific frozen bit sets from the plurality of frozen bit sets respectively according to bit positions of frozen bits. For example, if the bit length of the frozen bit set is four (i.e., four bits) and the bit length of the specific frozen bit set is determined as two (i.e., two bits), then the polar code encoder 11 may select two bits at preset bit positions (e.g., the first bit position and the second bit position) to form the specific frozen bit set according to the bit positions of the four bits.

In some embodiments, the polar code encoder 11 may also decide the plurality of specific frozen bit sets from the plurality of frozen bit sets respectively through random bit selection. For example, if the bit length of the frozen bit set is four (i.e., four bits) and the bit length of the specific frozen bit set is determined as two (i.e., two bits), then the polar code encoder 11 may randomly select two bits from the four bits to form the specific frozen bit set.

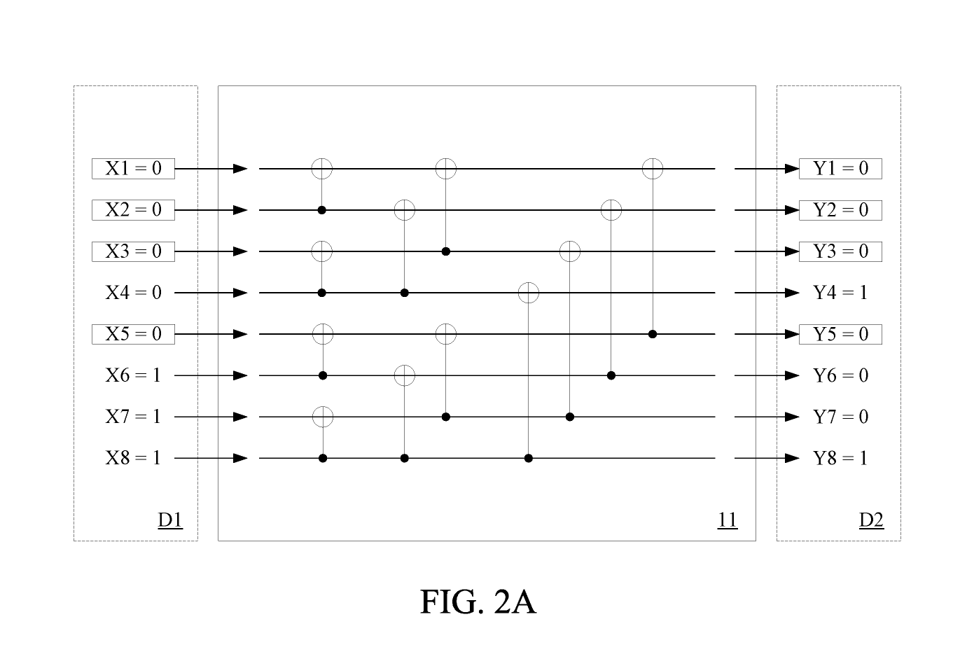

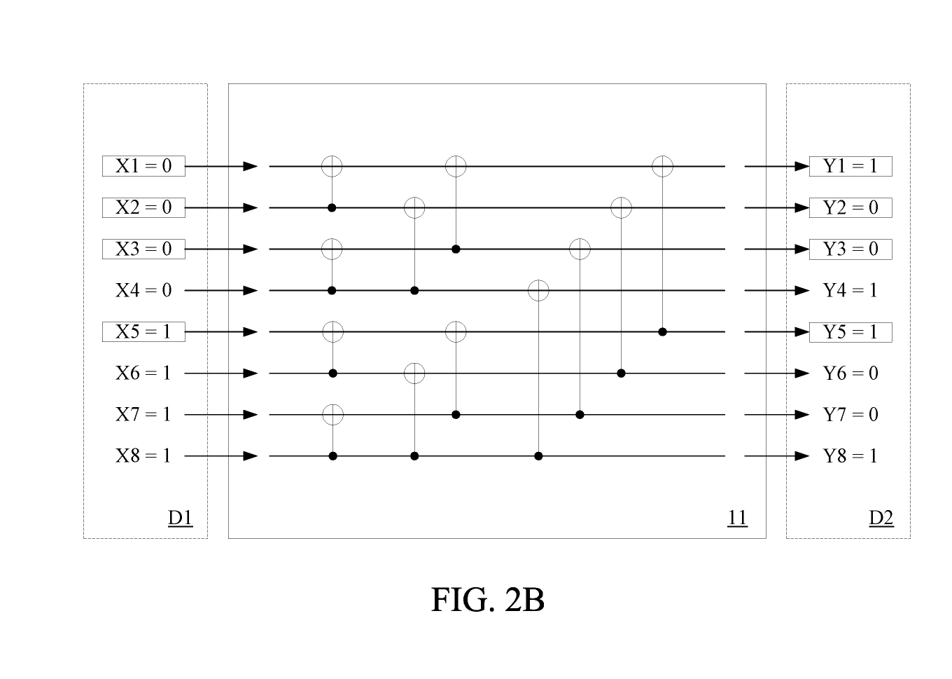

FIG. 2A to FIG. 2B are schematic views illustrating operation of a polar code encoder in one or more embodiments of the present invention. Contents shown in FIG. 2A and FIG. 2B are only for purpose of illustrating embodiments of the present invention instead of limiting the present invention. FIG. 2A to FIG. 2B present two first data D1 having different bit representations and two corresponding second data D2. Referring to FIG. 2A to FIG. 2B, if the bit lengths of the information bit sets (i.e., the information bit data carried in the digital input signal IN) comprised in the two first data D1 are all four (i.e., four information bits) and the code rate adopted by the polar code encoder 11 is ½, then the bit lengths of the frozen bit sets comprised in the two first data D1 are all four (i.e., four frozen bits). Therefore, the bit lengths of the two first data D1 are all eight (i.e., eight bits) and the bits are respectively represented by a bit X1, a bit X2, . . . , a bit X8, and the bit lengths of the two second data D2 are all eight (i.e., eight bits) and the bits are respectively represented by a bit Y1, a bit Y2, . . . , a bit Y8. Additionally, the four information bits of the information bit sets (i.e., the information bit data carried in the digital input signal IN) comprised in the two first data D1 are respectively represented by the bit X4, the bit X6, the bit X7 and the bit X8, and the four frozen bits of the frozen bit sets comprised in the two first data D1 are respectively represented by the bit X1, the bit X2, the bit X3 and the bit X5.

The polar code encoder 11 may select one or more specific frozen bits from the aforesaid four frozen bits (i.e., the bit X1, the bit X2, the bit X3 and the bit X5) according to the bit reliability, bit positions of the aforesaid four frozen bits or through random bit selection. For ease of description, in FIG. 2A to FIG. 2B, it is assumed that the bit length of the specific frozen bit set is one (i.e., one specific frozen bit), and the specific frozen bit is represented by the bit X5.

In the two first data D1, the bit X4, the bit X6, the bit X7 and the bit X8 (i.e., the aforesaid information bits) all have a value of “1”, while the bit X1, the bit X2 and the bit X3 (i.e., the aforesaid frozen bits) all have a value of “0”. Additionally, the bit X5 (i.e., the aforesaid specific frozen bit) has a value of “0” in FIG. 2A, while the bit X5 (i.e., the aforesaid specific frozen bit) has a value of “1” in FIG. 2B. In this case, as shown in FIG. 2A, the eight bits X1 to X8 comprised in the first data D1 may be represented as “00000111”, and the eight bits Y1 to Y8 comprised in the second data D2 may be represented as “00010001”. Additionally, as shown in FIG. 2B, the eight bits X1 to X8 comprised in the first data D1 may be represented as “00001111”, and the eight bits Y1 to Y8 comprised in the second data D2 may be represented as “10011001”. Therefore, two second data D2 having different bit representations can be generated simply by changing the value of a single bit (e.g., the bit X5).

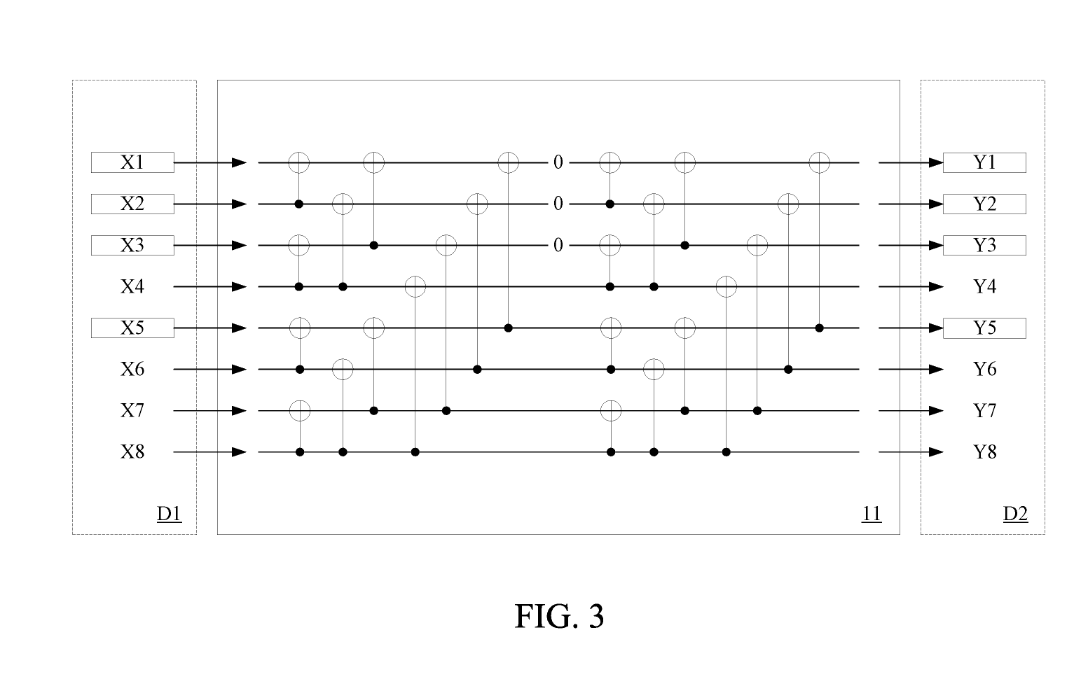

FIG. 3 is a schematic view illustrating operation of another polar code encoder in one or more embodiments of the present invention. Contents shown in FIG. 3 are only for purpose of illustrating embodiments of the present invention instead of limiting the present invention. Referring to FIG. 3, the polar code encoder 11 is a systematic polar code encoder, and it enables the bit representations of the information bits (e.g., the bit X4, the bit X6, the bit X7 and the bit X8) in the first data D1 to be the same as the bit representations of the information bits (e.g., the bit Y4, the bit Y6, the bit Y7 and the bit Y8) in the second data D2 by performing the same encoding procedures for two times and presetting the value of the frozen bit (e.g., to be zero) when the encoding procedure is performed for the second time. Therefore, no matter how the bit representations of the frozen bits (e.g., the bit X1, the bit X2, the bit X3 and the bit X5) in the first data D1 change, the bit representations of the information bits (e.g., the bit Y4, the bit Y6, the bit Y7 and the bit Y8) in the second data D2 are still the same as bit representations of the information bits (e.g., the bit X4, the bit X6, the bit X7 and the bit X8) in the first data D1. In other words, in FIG. 3, if the bit representations of the frozen bits (e.g., the bit X1, the bit X2, the bit X3 and the bit X5) in the first data D1 change, then the values of only at most four bits (i.e., the bit Y1, the bit Y2, the bit Y3 and the bit Y5) in the second data D2 will change.

Referring back to FIG. 1A and FIG. 1B, each time after the polar code encoder 11 encodes a first data D1 into a second data D2 (i.e., codes word), the modulator 13 may be configured to modulates the second data D2 into a third data D3. The constellation point number of the modulator is M=2^{m}, which means that every m bits of the second data D2 are modulated into a symbol of the third data D3.

After the modulator 13 modulates the second data D2 into the third data D3, the inverse discrete Fourier transformer 15 may be configured to transform the third data D3 (a frequency domain data) into a fourth data D4 (a time domain data). Taking the inverse fast Fourier transform as an example, the inverse discrete Fourier transformer 15 may transform the third data D3 into the fourth data D4 according to the following equation:

$${x}_{n} = \frac{1}{\sqrt{N}} {\sum }_{k = 0}^{N - 1} {d}_{k} {e}^{\frac{j 2 π nk}{N}} \qquad ( 1 )$$

wherein dₖ is the third data D3, xₙ is the fourth data D4, n represents discrete time points and N represents the length of the fourth data D4.

In some embodiments, each time after the modulator 13 modulates a second data D2 into the third data D3, the inverse discrete Fourier transformer 15 transforms the third data D3 into the fourth data D4 according to the equation (1). In some embodiments, in order to reduce the computation amount of the inverse discrete Fourier transform, the inverse discrete Fourier transformer 15 may also transform other pieces of third data D3 into the fourth data D4 based on a bit transformation look-up table (LUT) in addition to the first piece of third data D3.

Specifically, because a specific frozen bit set has r bits in total, p bits in the second data D2 and q symbols in the third data D3 may change accordingly if the bit representations of b bits (b is a positive integer smaller than or equal to r) in a specific frozen bit set of the first data D1 are changed (e.g., from zero to one). In the process of pre-establishing a bit transformation look-up table, a set of bit transformation look-up table inputs are established respectively for each of the p bits that may change in the second data D2, then a set of corresponding bit transformation look-up table outputs may be obtained through the modulator 13 and the inverse discrete Fourier transformer 15, and all the bit transformation look-up table inputs together with all the corresponding bit transformation look-up table outputs may constitute one bit transformation look-up table. For example, it is assumed that p bits in the second data D2 will change due to the change of the b bits in the first data D1, and the p bits of the second data D2 are respectively located at jᵢ^{th} positions (i is one of all positive integers between 1 and p with 1 and p included therein). For each i, the aforesaid set of bit transformation look-up table inputs can be obtained simply by setting the bit representation of the jᵢ^{th} position of the second data D2 into “1” while setting the bit representations of other positions into “0”, and then corresponding p sets of bit transformation look-up table outputs can be obtained after the aforesaid p sets of bit transformation look-up table inputs are all processed by the modulator 13 and the inverse discrete Fourier transformer 15, thereby establishing the bit transformation look-up table. Additionally, the bit transformation look-up table may also be pre-established by any external computing apparatuses or processors and stored in the baseband processing apparatus 1A or the baseband processing apparatus 1B.

After the bit length of the first data D1 is determined, the encoding structure of the polar code encoder 11 is also determined. Once the encoding structure of the polar code encoder 11 is determined, each of the baseband processing apparatus 1A and the baseband processing apparatus 1B can learn in advance the change in the value of which bit in the first data D1 will cause which bit(s) in the second data D2 to change accordingly. Taking FIG. 2A and FIG. 2B as an example, as the value of the bit X5 (i.e., the aforesaid specific frozen bit) changes, the values of the bit Y1 and the bit Y5 in the second data D2 change accordingly, but other bits in the second data D2 will not change accordingly. Therefore, except for the first piece of fourth data D4 that has to be obtained by the inverse discrete Fourier transform, the inverse discrete Fourier transformer 15 can obtain other pieces of fourth data D4 simply by adding the first piece of fourth data D4 with transformation results of one or more bits, of which the bit values are going to be changed in the fourth data D4 being computed currently, that are pre-stored in the bit transformation look-up table, based on the linear characteristic of the inverse discrete Fourier transform.

Each time after the inverse discrete Fourier transformer 15 transforms the third data D3 into the fourth data D4, the controller 17 may be configured to calculate a peak to average power ratio (PAPR) of the fourth data D4 according to the following equation:

$$PAPR = \frac{max ( {\vert {x}_{n} \vert}^{2} )}{E ( {\vert {x}_{n} \vert}^{2} )} \qquad ( 2 )$$

wherein PAPR is the peak to average power ratio, xₙ is the fourth data D4, max(|xₙ|²) is the maximum power of the fourth data D4, and E(|xₙ|²) is the average power of the fourth data D4.

After the PAPRs of all the fourth data D4 are calculated, the controller 17 may select a fourth data candidate from the plurality of fourth data as the digital output signal OUT, and the fourth data candidate corresponds to the smallest one of all the PAPRs.

Subsequent processing performed on the digital output signal OUT selected by the controller 17 is done in the same principle as a common orthogonal frequency-division multiplexing transmitter. For example, the digital output signal OUT may be transformed into an analog signal, next medium frequency transformation and radio frequency transformation are performed on the analog signal, and then an orthogonal frequency-division multiplexing signal is transmitted to an orthogonal frequency-division multiplexing receiver.

An orthogonal frequency-division multiplexing signal transmitted by an orthogonal frequency-division multiplexing transmitter comprising the baseband processing apparatus 1A or the baseband processing apparatus 1B may be received and processed by a conventional orthogonal frequency-division multiplexing receiver, and does not need to be received and processed by an orthogonal frequency-division multiplexing receiver of a special design. For example, the conventional orthogonal frequency-division multiplexing receiver will first transform the received orthogonal frequency-division multiplexing signal into a digital baseband signal, and then perform Fourier transform, demodulation and finally decoding on the digital baseband signal. Corresponding to the polar code encoder 11 adopting the polar code, a successive cancellation (SC) decoder or an SC-List decoder may be adopted in the decoding stage. The basic core of the SC decoder and the SC-List decoder is to retain one or more decoding paths of the highest probability during the decoding process as the output of the decoder.

It shall be appreciated that, in the embodiments of the present invention, the orthogonal frequency-division multiplexing receiver used in combination with the orthogonal frequency-division multiplexing transmitter that comprises the baseband processing apparatus 1A or the baseband processing apparatus 1B can decode the aforesaid digital baseband signal without the need of side information, e.g., information such as bit positions and bit representations of specific frozen bit sets in the first data D1. Therefore, different from the orthogonal frequency-division multiplexing transmitter which has to additionally transmit r bits (i.e., side information) by adopting the selected mapping (SLM), the orthogonal frequency-division multiplexing transmitter comprising the baseband processing apparatus 1A or the baseband processing apparatus 1B does not need to transmit the side information. It shall be additionally appreciated that, in the first data D1, the frozen bits comprised in the frozen bit set are not the information bit data carried in the digital input signal IN, so the change in bit representations of the frozen bits comprised in the frozen bit set will hardly affect the operation and effects of the SC decoder and the SC-List decoder.

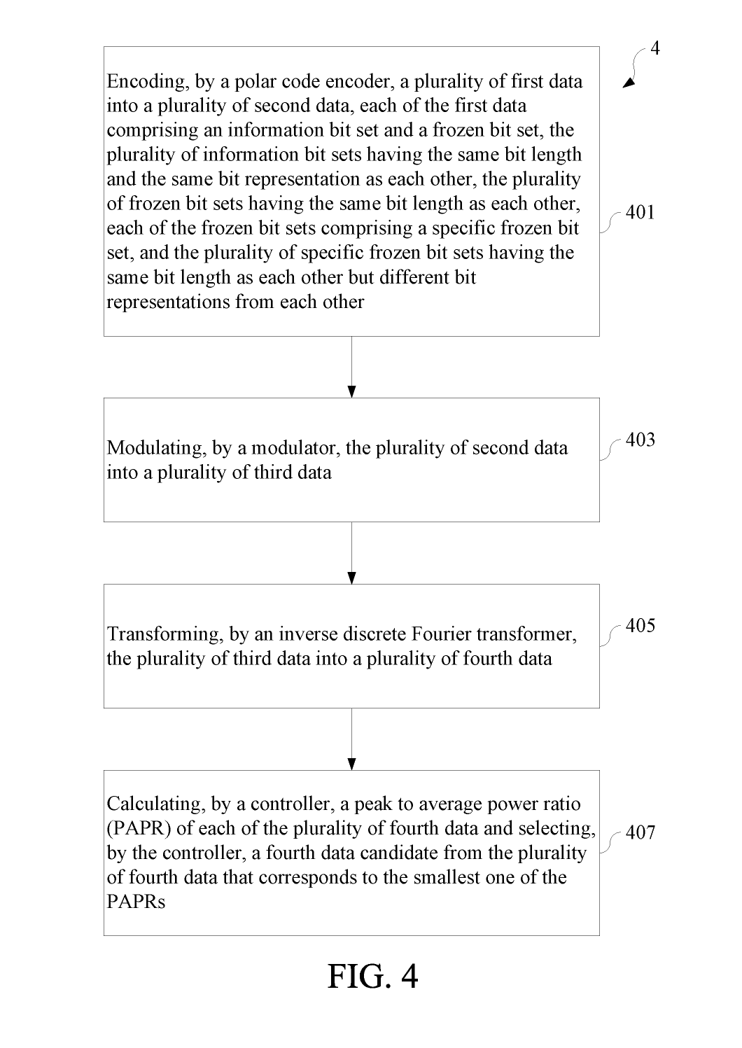

FIG. 4 illustrates a baseband processing method based on OFDM in one or more embodiments of the present invention. Contents shown in FIG. 4 are only for purpose of illustrating embodiments of the present invention instead of limiting the present invention. Referring to FIG. 4, a baseband processing method 4 based on orthogonal frequency-division multiplexing (OFDM) may comprise the following steps:

encoding, by a polar code encoder, a plurality of first data into a plurality of second data, each of the first data comprising an information bit set and a frozen bit set, the plurality of information bit sets having the same bit length and the same bit representation as each other, the plurality of frozen bit sets having the same bit length as each other, each of the frozen bit sets comprising a specific frozen bit set, and the plurality of specific frozen bit sets having the same bit length as each other but different bit representations from each other (labeled as step 401);

modulating, by a modulator, the plurality of second data into a plurality of third data (labeled as step 403);

transforming, by an inverse discrete Fourier transformer, the plurality of third data into a plurality of fourth data (labeled as step 405); and

calculating, by a controller, a peak to average power ratio (PAPR) of each of the plurality of fourth data and selecting, by the controller, a fourth data candidate from the plurality of fourth data that corresponds to the smallest one of the PAPRs (labeled as step 407).

In some embodiments, the baseband processing method 4 based on OFDM may further comprise the following step: deciding, by the polar code encoder, the plurality of specific frozen bit sets from the plurality of frozen bit sets respectively according to bit reliability of frozen bits.

In some embodiments, the baseband processing method 4 based on OFDM may further comprise the following step: deciding, by the polar code encoder, the plurality of specific frozen bit sets from the plurality of frozen bit sets respectively according to bit positions of frozen bits.

In some embodiments, the baseband processing method 4 based on OFDM may further comprise the following step: deciding, by the polar code encoder, the plurality of specific frozen bit sets from the plurality of frozen bit sets respectively through random bit selection.

In some embodiments, the step 405 may comprise: transforming, by the inverse discrete Fourier transformer, the plurality of third data into the plurality of fourth data based on a bit transformation look-up table.

In some embodiments, the step 405 may comprise: transforming, by the inverse discrete Fourier transformer, the plurality of third data into the plurality of fourth data based on a bit transformation look-up table. Additionally, in these embodiments, the polar code encoder is a systematic polar code encoder.

In some embodiments, in the baseband processing method 4 based on OFDM, the number of the plurality of first data is 2r, where r is a positive integer.

In some embodiments, in the baseband processing method 4 based on OFDM, the plurality of bit lengths of the plurality of frozen bit sets depend on a code rate.

In some embodiments, the baseband processing method 4 based on OFDM may be implemented on the baseband processing apparatus 1A or the baseband processing apparatus 1B. All corresponding steps of the baseband processing method 4 based on OFDM shall be clearly appreciated by a person having ordinary skill in the art based on the above description of the baseband processing apparatus 1A and the baseband processing apparatus 1B, and thus will not be further described herein.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A baseband processing apparatus based on orthogonal frequency-division multiplexing (OFDM), comprising:
a polar code encoder, being configured to encode a plurality of first data into a plurality of second data, each of the first data comprising an information bit set and a frozen bit set, the plurality of information bit sets having the same bit length and the same bit representation as each other, the plurality of frozen bit sets having the same bit length as each other, each of the frozen bit sets comprising a specific frozen bit set, and the plurality of specific frozen bit sets having the same bit length as each other but different bit representations from each other;
a modulator electrically connected with the polar code encoder, being configured to modulate the plurality of second data into a plurality of third data;
an inverse discrete Fourier transformer electrically connected with the modulator, being configured to transform the plurality of third data into a plurality of fourth data; and
a controller electrically connected with the inverse discrete Fourier transformer, being configured to calculate a peak to average power ratio (PAPR) of each of the plurality of fourth data and select a fourth data candidate from the plurality of fourth data that corresponds to the smallest one of the PAPRs.

2. The baseband processing apparatus of claim 1, wherein the polar code encoder is further configured to decide the plurality of specific frozen bit sets from the plurality of frozen bit sets respectively according to bit reliability of frozen bits.

3. The baseband processing apparatus of claim 1, wherein the polar code encoder is further configured to decide the plurality of specific frozen bit sets from the plurality of frozen bit sets respectively according to bit positions of frozen bits.

4. The baseband processing apparatus of claim 1, wherein the polar code encoder is further configured to decide the plurality of specific frozen bit sets from the plurality of frozen bit sets respectively through random bit selection.

5. The baseband processing apparatus of claim 1, wherein the inverse discrete Fourier transformer transforms the plurality of third data into the plurality of fourth data based on a bit transformation look-up table.

6. The baseband processing apparatus of claim 1, wherein the polar code encoder is a systematic polar code encoder.

7. The baseband processing apparatus of claim 1, wherein the number of the plurality of first data is 2^{r}, where r is a positive integer.

8. The baseband processing apparatus of claim 1, wherein the plurality of bit lengths of the plurality of frozen bit sets depend on a code rate.

9. A baseband processing method based on orthogonal frequency-division multiplexing (OFDM), comprising:
encoding, by a polar code encoder, a plurality of first data into a plurality of second data, each of the first data comprising an information bit set and a frozen bit set, the plurality of information bit sets having the same bit length and the same bit representation as each other, the plurality of frozen bit sets having the same bit length as each other, each of the frozen bit sets comprising a specific frozen bit set, and the plurality of specific frozen bit sets having the same bit length as each other but different bit representations from each other;
modulating, by a modulator, the plurality of second data into a plurality of third data;
transforming, by an inverse discrete Fourier transformer, the plurality of third data into a plurality of fourth data; and
calculating, by a controller, a peak to average power ratio (PAPR) of each of the plurality of fourth data and selecting, by the controller, a fourth data candidate from the plurality of fourth data that corresponds to the smallest one of the PAPRs.

10. The baseband processing method of claim 9, further comprising the following step: deciding, by the polar code encoder, the plurality of specific frozen bit sets from the plurality of frozen bit sets respectively according to bit reliability of frozen bits.

11. The baseband processing method of claim 9, further comprising the following step: deciding, by the polar code encoder, the plurality of specific frozen bit sets from the plurality of frozen bit sets respectively according to bit positions of frozen bits.

12. The baseband processing method of claim 9, further comprising the following step: deciding, by the polar code encoder, the plurality of specific frozen bit sets from the plurality of frozen bit sets respectively through random bit selection.

13. The baseband processing method of claim 9, wherein the step of transforming the plurality of third data into a plurality of fourth data comprises: transforming, by the inverse discrete Fourier transformer, the plurality of third data into the plurality of fourth data based on a bit transformation look-up table.

14. The baseband processing method of claim 9, wherein the polar code encoder is a systematic polar code encoder.

15. The baseband processing method of claim 9, wherein the number of the plurality of first data is 2^{r}, where r is a positive integer.

16. The baseband processing method of claim 9, wherein the plurality of bit lengths of the plurality of frozen bit sets depend on a code rate.
